(19) United States
(12) Patent Application Publication
(10) Pub. No.: US 2018/0364903 A1
(43) Pub. Date: Dec. 20, 2018

(54) DISPLAY CONTROL APPARATUS AND DISPLAY CONTROL METHOD

(71) Applicant: MITSUBISHI ELECTRIC CORPORATION, Tokyo (JP)

(72) Inventors: Hiroki EBINA, Tokyo (JP); Mitsuo SHIMOTANI, Tokyo (JP)

(73) Assignee: MITSUBISHI ELECTRIC CORPORATION, Tokyo (JP)

(21) Appl. No.: 15/782,009

(22) PCT Filed: Feb. 8, 2016
(86) PCT No.: PCT/JP2016/053670

§ 371 Date: Jun. 6, 2018

(51) Int. Cl. G06F 3/0488; G06F 3/041; G06F 3/0484

(52) U.S. Cl. CPC G06F 3/04883; G06F 3/04847; G06F 3/04842; G06F 3/0416

(57) ABSTRACT

The present invention has an object to provide a display control apparatus capable of enhancing visibility of an object input in handwriting. A display control apparatus according to the present invention is a display control apparatus for controlling display of a map. The display control apparatus includes a handwriting input unit for accepting a handwriting input of an object on the map, an attribute setting unit for setting presence or absence of an attribute indicating whether or not a display form of the object is to be changed in accordance with a display form or a display environment of the map, and a display controller for controlling, when the attribute is present, such that the object is added to the map to be displayed in the display while changing the display form of the object in accordance with the display form or the display environment of the map.

### TECHNICAL FIELD

The present invention relates to a display control apparatus for adding an object input in handwriting to a map to display the object at the time of displaying the map in a display.

### BACKGROUND ART

Hitherto, there is disclosed a technology of inputting an object in handwriting to a map displayed in a display, and changing the size of the object input in handwriting in accordance with a scale of the map (refer to Patent Document 1, for example).

### PRIOR ART DOCUMENT

### Patent Document

Patent Document 1: Japanese Patent Application Laid-Open No. 2014-174725

### SUMMARY

### Problem to be Solved by the Invention

In Patent Document 1, the size of an object input in handwriting is uniformly changed in accordance with a scale of a map, and hence visibility may be deteriorated in a case where the object input in handwriting is reduced in size, for example.

The present invention has been made in order to solve the problem as described above, and has an object to provide a display control apparatus capable of enhancing visibility of an object input in handwriting.

### Means to Solve the Problem

In order to solve the problem as described above, a display control apparatus according to the present invention is a display control apparatus for controlling display of a map in a display. The display control apparatus includes a handwriting input unit for accepting a handwriting input of an object on the map displayed in the display, an attribute setting unit for setting presence or absence of an attribute indicating whether or not a display form of the object is to be changed in accordance with a display form or a display environment of the map, and a display controller for controlling, when the attribute is present, such that the object is added to the map to be displayed in the display while changing the display form of the object in accordance with the display form or the display environment of the map based on the presence or absence of the attribute set by the attribute setting unit.

Further, a display control method according to the present invention is a display control method of controlling display of a map in a display. The display control method includes accepting a handwriting input of an object on the map displayed in the display, setting presence or absence of an attribute indicating whether or not a display form of the object is to be changed in accordance with a display form or a display environment of the map, and controlling, when the attribute is present, such that the object is added to the map to be displayed in the display while changing the display form of the object in accordance with the display form or the display environment of the map based on the set presence or absence of the attribute.

### Effects of the Invention

According to the present invention, the display control apparatus is a display control apparatus for controlling display of a map in a display. The display control apparatus includes the handwriting input unit for accepting a handwriting input of an object on the map displayed in the display, the attribute setting unit for setting presence or absence of an attribute indicating whether or not a display form of the object is to be changed in accordance with a display form or a display environment of the map, and the display controller for controlling, when the attribute is present, such that the object is added to the map to be displayed in the display while changing the display form of the object in accordance with the display form or the display environment of the map based on the presence or absence of the attribute set by the attribute setting unit. Hence, visibility of the object input in handwriting can be enhanced.

Further, the display control method is a display control method of controlling display of a map in a display. The display control method includes accepting a handwriting input of an object on the map displayed in the display, setting presence or absence of an attribute indicating whether or not a display form of the object is to be changed in accordance with a display form or a display environment of the map, and controlling, when the attribute is present, such that the object is added to the map to be displayed in the display while changing the display form of the object in accordance with the display form or the display environment of the map based on the set presence or absence of the attribute. Hence, visibility of the object input in handwriting can be enhanced.

The object, features, aspects, and advantages of the present invention become more obvious with the following detailed description and the attached drawings.

### BRIEF DESCRIPTION OF DRAWINGS

FIG. 1 is a block diagram illustrating an example of a configuration of a display control apparatus according to a first embodiment of the present invention.

FIG. 2 is a block diagram illustrating an example of a hardware configuration of the display control apparatus according to the first embodiment of the present invention.

FIG. 3 is a block diagram illustrating an example of a configuration of a display control apparatus according to the first embodiment of the present invention.

FIG. 4 is a block diagram illustrating an example of a hardware configuration of the display control apparatus according to the first embodiment of the present invention.

FIG. 5 is a flowchart illustrating an example of operations of the display control apparatus according to the first embodiment of the present invention.

FIG. 6 is a diagram illustrating an example of a handwriting input according to the first embodiment of the present invention.

FIG. 7 is a diagram illustrating an example of a handwriting input according to the first embodiment of the present invention.

FIG. 8 is a diagram illustrating an example of a set change attribute and the like according to the first embodiment of the present invention.

FIG. 9 is a flowchart illustrating an example of operations of the display control apparatus according to the first embodiment of the present invention.

FIG. 10 is a diagram illustrating an example of a display of a map according to the first embodiment of the present invention.

FIG. 11 is a diagram illustrating an example of a display of a map according to the first embodiment of the present invention.

FIG. 12 is a diagram illustrating an example of a display of a map according to the first embodiment of the present invention.

FIG. 13 is a flowchart illustrating an example of operations of the display control apparatus according to the second embodiment of the present invention.

FIG. 14 is a diagram illustrating an example of a set color information attribute and the like according to the second embodiment of the present invention.

FIG. 15 is a flowchart illustrating an example of operations of the display control apparatus according to the second embodiment of the present invention.

FIG. 16 is a block diagram illustrating an example of a configuration of a display control system according to the embodiments of the present invention.

FIG. 17 is a block diagram illustrating an example of a configuration of the display control system according to the embodiments of the present invention.

### DESCRIPTION OF EMBODIMENTS

Embodiments of the present invention are described below on the basis of the drawings.

### First Embodiment

<Configuration>

A configuration of a display control apparatus according to an embodiment of the present invention is described.

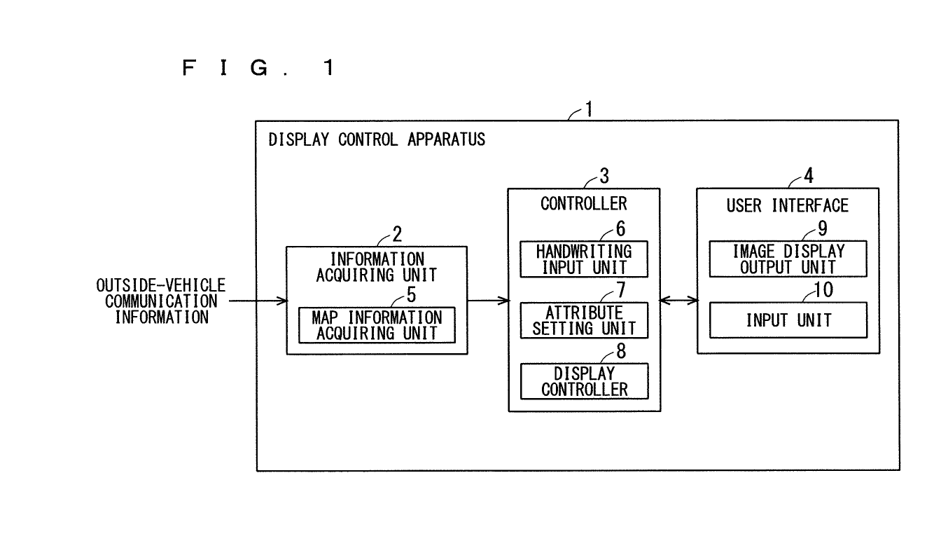

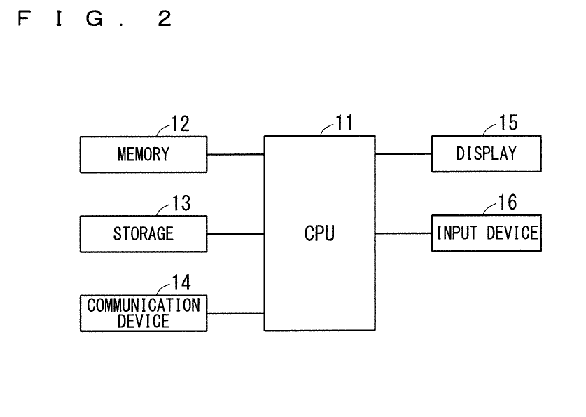

FIG. 1 is a block diagram illustrating an example of a configuration of a display control apparatus 1 according to this first embodiment. FIG. 2 is a block diagram illustrating an example of a hardware configuration of the display control apparatus 1.

As illustrated in FIG. 1, the display control apparatus 1 includes an information acquiring unit 2, a controller 3, and a user interface 4.

The information acquiring unit 2 includes a map information acquiring unit 5. The map information acquiring unit 5 acquires map information. Note that, the map information acquiring unit 5 may acquire map information as outside-vehicle communication information from the outside via a communication device 14, and may store the acquired map information in a storage 13. Further, the map information may be stored in the storage 13 in advance. The storage 13 may be, for example, an SD (registered trademark), a hard disk drive (HDD), flash memory, or the like. The communication device 14 is capable of sending and receiving various pieces of information through communication.

The controller 3 includes a handwriting input unit 6, an attribute setting unit 7, and a display controller 8. The handwriting input unit 6 accepts an object input in handwriting on a map displayed in a display 15 by the user using an input device 16. The display 15 may be, for example, a liquid crystal display or the like. The input device 16 may be, for example, a touch panel arranged on a liquid crystal display or the like, but any device capable of a handwriting input suffices.

The attribute setting unit 7 sets presence or absence of an attribute indicating whether or not a display form of an object input in handwriting is to be changed in accordance with a display form or a display environment of a map. When an attribute is present, based on the presence or absence of an attribute set by the attribute setting unit 7, the display controller 8 performs control such that the object is added to the map to be displayed in the display 15 while changing a display form of the object in accordance with a display form or a display environment of the map.

The user interface 4 includes an image display output unit 9 and an input unit 10. The image display output unit 9 follows the control of the display controller 8 to output an image (for example, at least one of the map and the object input in handwriting) to the display 15. The input unit 10 accepts information input by the user using the input device 16.

Each function of the map information acquiring unit 5, the handwriting input unit 6, the attribute setting unit 7, the display controller 8, the image display output unit 9, and the input unit 10 in the display control apparatus 1 is realized by a processing circuit. That is, the display control apparatus 1 includes a processing circuit for acquiring map information, accepting an object input in handwriting, setting presence or absence of an attribute, and when an attribute is present, controlling such that the object is added to the map to be displayed in the display 15 while changing a display form of the object in accordance with a display form or a display environment of the map, outputting an image to the display 15, and accepting information input by the user using the input device 16. The processing circuit is a central processing unit (CPU) 11 (also referred to as a central processor, a processing unit, an arithmetic unit, a microprocessor, a microcomputer, or a digital signal processor (DSP)) for executing a program stored in memory 12.

Each function of the map information acquiring unit 5, the handwriting input unit 6, the attribute setting unit 7, the display controller 8, the image display output unit 9, and the input unit 10 in the display control apparatus 1 is realized by software, firmware, or a combination of software and firmware. Software or firmware is described as a program, and is stored in the memory 12. The processing circuit realizes the function of each unit by reading out and executing programs stored in the memory 12. That is, the display control apparatus 1 includes the memory 12 for storing programs to eventually execute a step of acquiring map information, a step of accepting an object input in handwriting, a step of setting presence or absence of an attribute, a step of performing, when an attribute is present, control such that the object is added to the map to be displayed in the display 15 while changing a display form of the object in accordance with a display form or a display environment of the map, a step of outputting an image to the display 15, and a step of accepting information input by the user using the input device 16. Further, it can be said that those programs make a computer execute procedures or methods of the map information acquiring unit 5, the handwriting input unit 6, the attribute setting unit 7, the display controller 8, the image display output unit 9, and the input unit 10. Here, as the memory, for example, non-volatile or volatile semiconductor memory such as random access memory (RAM), read only memory (ROM), flash memory, erasable programmable read only memory (EPROM), and electrically erasable programmable read only memory (EEPROM), a magnetic disk, a flexible disk, an optical disc, and the like are applicable.

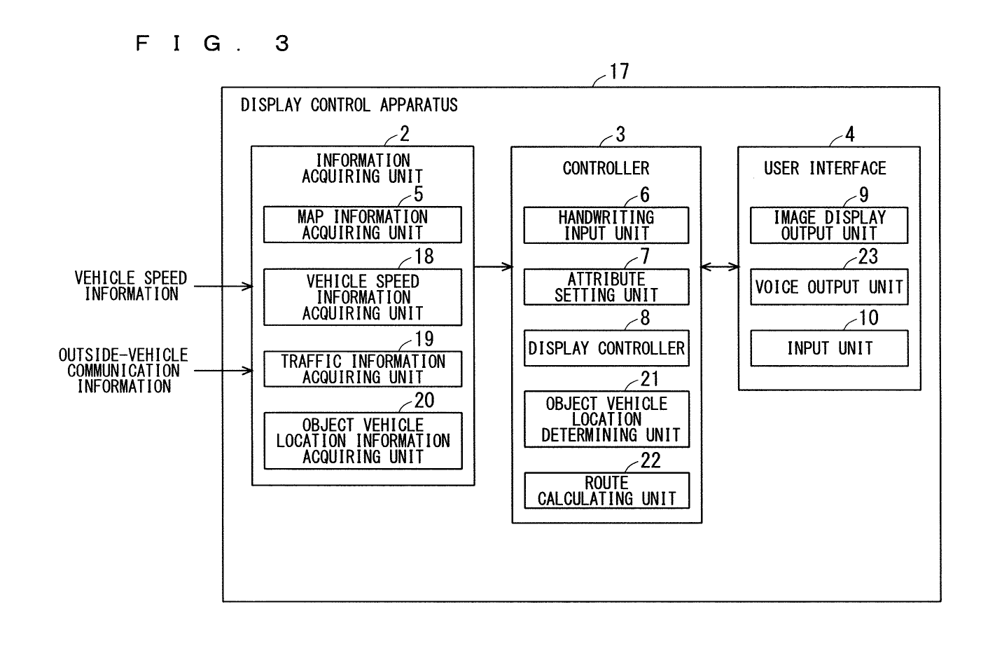

FIG. 3 is a block diagram illustrating an example of a configuration of a display control apparatus 17, which is a diagram illustrating an example of a case where the display control apparatus 1 of FIG. 1 is applied to a navigation device. FIG. 4 is a block diagram illustrating an example of a hardware configuration of the display control apparatus 17. Components of the display control apparatus 17 of FIG. 3 that are newly added to the display control apparatus 1 of FIG. 1 are mainly described below.

The information acquiring unit 2 includes the map information acquiring unit 5, a vehicle speed information acquiring unit 18, a traffic information acquiring unit 19, and an object vehicle location information acquiring unit 20. The vehicle speed information acquiring unit 18 acquires vehicle speed information from a vehicle speed sensor that is provided in a vehicle (object vehicle) installed with the display control apparatus 17. The traffic information acquiring unit 19 acquires traffic information as outside-vehicle communication information from the outside via the communication device 14. The object vehicle location information acquiring unit 20 acquires current location information of an object vehicle using, for example, a global positioning system (GPS).

The controller 3 includes the handwriting input unit 6, the attribute setting unit 7, the display controller 8, an object vehicle location determining unit 21, and a route calculating unit 22. The object vehicle location determining unit 21 determines a current location of the object vehicle on a map based on current location information of an object vehicle acquired by the object vehicle location information acquiring unit 20 and map information acquired by the map information acquiring unit 5. The route calculating unit 22 calculates a location of the object vehicle determined by the object vehicle location determining unit 21 and a route to a destination set by the user using the input device 16.

The user interface 4 includes the image display output unit 9, the input unit 10, and a voice output unit 23. The voice output unit 23 outputs, to a voice output device 24, voice guidance information for guiding the user to a destination based on a route calculated by the route calculating unit 22, for example.

Each function of the vehicle speed information acquiring unit 18, the traffic information acquiring unit 19, the object vehicle location information acquiring unit 20, the object vehicle location determining unit 21, the route calculating unit 22, and the voice output unit 23 in the display control apparatus 17 is realized by a processing circuit. That is, the display control apparatus 17 includes a processing circuit for acquiring speed information, acquiring traffic information, determining a current location of an object vehicle on a map, and calculating a route. The processing circuit is the CPU 11 for executing a program stored in the memory 12.

Each function of the vehicle speed information acquiring unit 18, the traffic information acquiring unit 19, the object vehicle location information acquiring unit 20, the object vehicle location determining unit 21, the route calculating unit 22, and the voice output unit 23 in the display control apparatus 17 is realized by software, firmware, or a combination of software and firmware. Software or firmware is described as a program, and is stored in the memory 12. The processing circuit realizes the function of each unit by reading out and executing a program stored in the memory 12. That is, the display control apparatus 17 includes the memory 12 for storing programs to eventually execute a step of acquiring speed information, a step of acquiring traffic information, a step of determining a current location of an object vehicle on a map, and a step of calculating a route. Further, it can be said that those programs make a computer execute procedures or methods of the vehicle speed information acquiring unit 18, the traffic information acquiring unit 19, the object vehicle location information acquiring unit 20, the object vehicle location determining unit 21, the route calculating unit 22, and the voice output unit 23. Here, as the memory, for example, non-volatile or volatile semiconductor memory such as RAM, ROM, flash memory, EPROM, and EEPROM, a magnetic disk, a flexible disk, an optical disc, and the like are applicable.

<Operations>

Next, operations of the display control apparatus according to this first embodiment are described. Note that, operations of the display control apparatus 1 (refer to FIG. 1) are described below, but the same applies to the display control apparatus 17 (refer to FIG. 3) as well. Further, in this first embodiment, description is given of a case where a display form of an object input in handwriting is changed in accordance with a display form of a map.

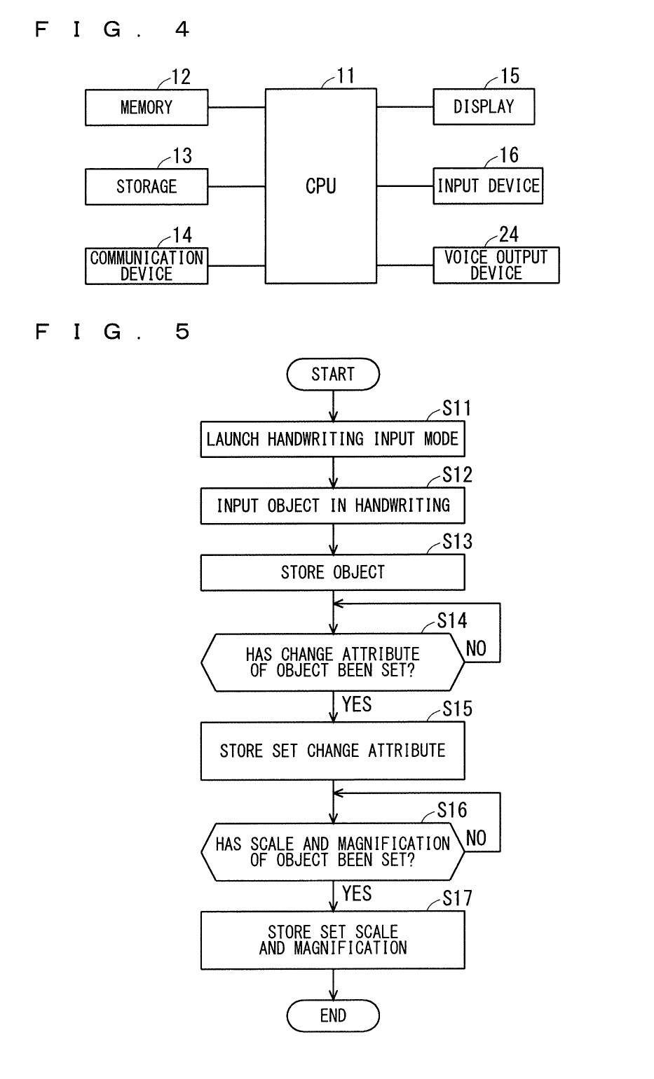

FIG. 5 is a flowchart illustrating an example of operations of the display control apparatus 1 according to this first embodiment, which illustrates an example of operations at the time when the user inputs an object on a map in handwriting.

In Step S11, the user operates the input device 16 to launch a handwriting input mode. At this time, a map is displayed in the display 15.

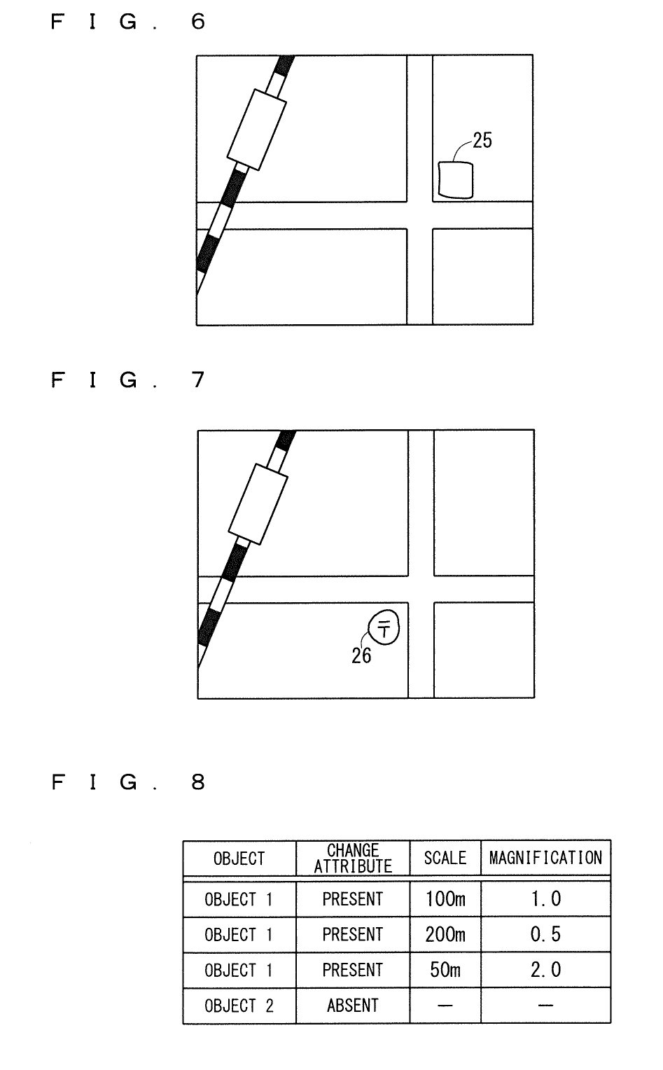

In Step S12, the handwriting input unit 6 accepts a handwriting input of an object on the map. Specifically, the user operates the input device 16 to input an object in handwriting on the map displayed in the display 15. FIGS. 6 and 7 are each a diagram illustrating an example of a handwriting input. FIG. 6 is an illustration of a state in which a constructed-structure mark 25 is input in handwriting on a map. FIG. 7 is an illustration of a state in which a landmark 26 is input in handwriting on a map.

In Step S13, the handwriting input unit 6 stores an object (constructed-structure mark 25 or landmark 26) input in handwriting in the storage 13. Note that, the object is associated with location information on a map so as to be stored in the storage 13.

In Step S14, the attribute setting unit 7 determines whether or not the user has set a change attribute indicating whether or not a size being a display form of an object input in handwriting is to be changed in accordance with a display form of a map. Specifically, the user sets a change attribute for each object input in handwriting. The change attribute may be set in such a manner that the user selects “present” or “absent” of a change attribute in a selection screen displayed in the display 15, for example, but the setting is not limited thereto. Here, the object with a change attribute being “present” may be a constructed structure such as a building (constructed-structure mark 25 of FIG. 6, for example), a road line, and the like. The object with a change attribute being “absent” may be a landmark (landmark 26 of FIG. 7, for example), a traffic regulation mark, and the like.

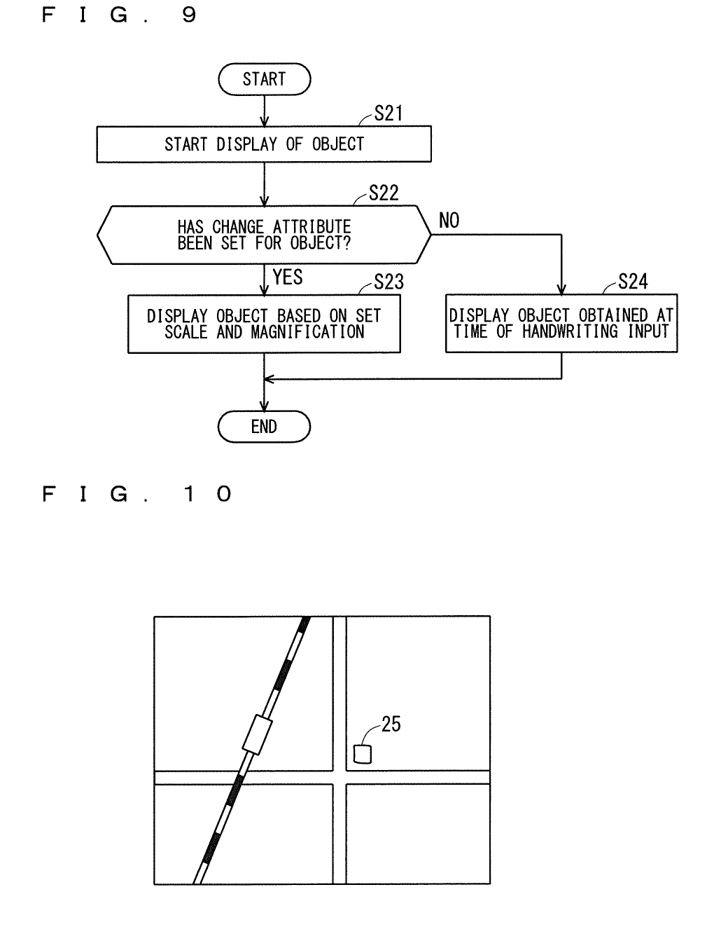

In Step S15, the attribute setting unit 7 stores a change attribute set by the user in the storage 13 (refer to FIG. 8). Note that, in FIG. 8, an object 1 corresponds to the constructed-structure mark 25 of FIG. 6, and an object 2 corresponds to the landmark 26 of FIG. 7.

In Step S16, the attribute setting unit 7 determines whether or not the user has set a scale and magnification for an object set to have a change attribute being “present.”

Specifically, for example, the user sets, in accordance with a scale of a map, magnification with reference to the size of an object input in handwriting. For example, magnification of an object is set to be “1.0” when a scale of a map is “100 m,” magnification of an object is set to be “0.5” when a scale of a map is “200 m,” and magnification of an object is set to be “2.0” when a scale of a map is “50 m.”

Note that, a scale and magnification of an object may be set in such a manner that the user selects (or directly inputs) a scale and magnification of an object in a selection screen displayed in the display 15, for example, but the setting is not limited thereto. For example, a reference scale and magnification may be set so as to automatically calculate the size (magnification) of an object in accordance with a change proportion of a scale.

In Step S17, the attribute setting unit 7 stores a scale and magnification set by the user in the storage 13 (refer to FIG. 8).

FIG. 9 is a flowchart illustrating an example of operations of the display control apparatus 1 according to this first embodiment, which illustrates an example of operations at the time when the user adds an object input in handwriting to a map to display the object in the display 15.

In Step S21, the display controller 8 starts a process for adding an object input in handwriting by the user to a map to display the object in display 15. Specifically, at the time of displaying, in the display 15, a map of a location associated with an object stored in the storage 13, the display controller 8 starts a process for adding the object to the map to display the object in the display 15.

In Step S22, the display controller 8 determines whether or not a change attribute is set for an object to be added to a map. In a case where a change attribute is set for an object, the process proceeds to Step S23. On the other hand, in a case where a change attribute is not set for an object, the process proceeds to Step S24.

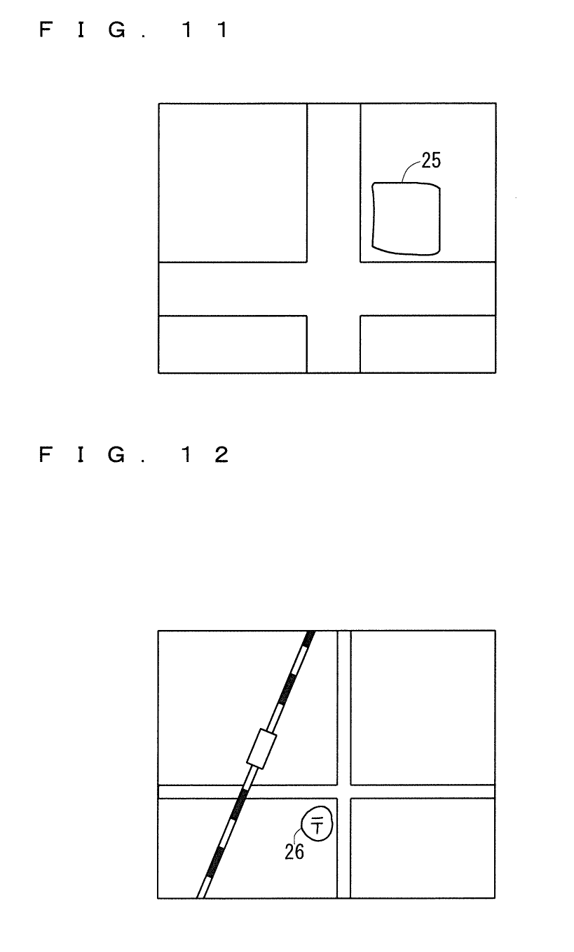

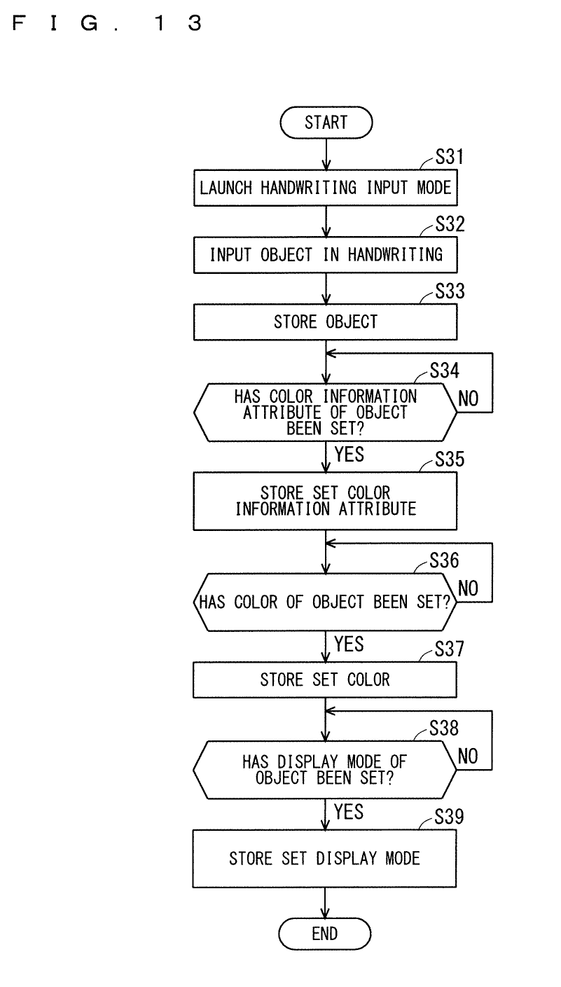

In Step S23, the display controller 8 controls the image display output unit 9 to make the image display output unit 9 add an object to a map to display the object in the display 15 based on a set scale and magnification. That is, the display controller 8 controls the image display output unit 9 to make the image display output unit 9 add an object to a map to display the object in the display 15 while changing a display form of the object in accordance with a display form of the map. FIGS. 10 and 11 are each a diagram illustrating an example of a case where an object (constructed-structure mark 25) is added to a map to be displayed in the display 15. Note that, the constructed-structure mark 25 is herein assumed to be the object 1 of FIG. 8. As illustrated in FIG. 10, in a case where a scale of a map is “200 m,” the constructed-structure mark 25 is displayed in a size 0.5 times as large as that obtained at the time of the handwriting input (refer to FIG. 6). Further, as illustrated in FIG. 11, in a case where a scale of a map is “50 m,” the constructed-structure mark 25 is displayed in a size 2.0 times as large as that obtained at the time of the handwriting input.

In Step S24, the display controller 8 controls the image display output unit 9 to make the image display output unit 9 add an object obtained at the time of the handwriting input to a map to display the object in the display 15. FIG. 12 is a diagram illustrating an example of a case where an object (landmark 26) is added to a map to be displayed in the display 15. Note that, the landmark 26 is herein assumed to be the object 2 of FIG. 8. As illustrated in FIG. 12, in a case where a scale of a map is “200 m,” for example, the landmark 26 is displayed in the same size as that obtained at the time of the handwriting input. That is, even when a scale (display form) of a map is changed, the size of an objected to be added to the map is not changed.

Based on the above description, according to this first embodiment, for each object input in handwriting, whether or not the size of the object is to be changed in accordance with a scale of a map is set. Accordingly, visibility of an object input in handwriting can be enhanced further than that in a case where the size of an object input in handwriting is uniformly changed in accordance with a scale of a map.

### Modified Example

For example, when the size of an object input in handwriting is intended to be reduced in accordance with the reduction in scale of a map, the object is less easily recognizable if the scale is reduced further beyond a certain scale, which may result in deteriorating visibility of the object. As a countermeasure for such a case, there may be employed such a setting that the size of an object is reduced to a certain scale, and the size of the object is not further reduced but is fixed when the scale is reduced further than the certain scale.

Specifically, the setting may be conducted in such a manner that the user selects “present,” “absent,” or “changeable” of a change attribute in a selection screen displayed in the display 15, for example (refer to Step S14 of FIG. 5). In a case where the user selects “changeable,” a range of a scale of a map where the size of an object is changeable and a range of a scale of a map where the size of an object is fixed are set.

Through the above-mentioned settings, visibility of an object input in handwriting can be further enhanced.

### Second Embodiment

In the second embodiment of the present invention, description is given of a case where a display form of an object input in handwriting is changed in accordance with a display environment of a map. Note that, the main configuration is the same as that of the first embodiment (refer to FIGS. 1 and 3), and hence detailed description thereof is herein omitted. Operations of the display control apparatus 1 (refer to FIG. 1) are described below, but the same applies to the display control apparatus 17 (refer to FIG. 3) as well.

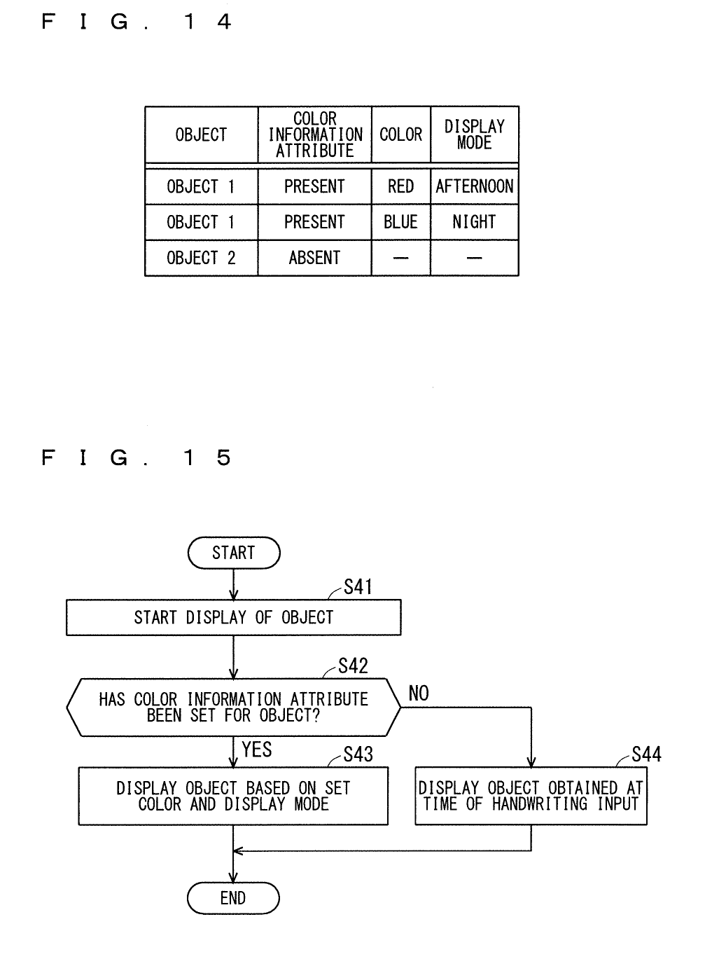

FIG. 13 is a flowchart illustrating an example of operations of the display control apparatus 1 according to this second embodiment, which illustrates an example of operations at the time when the user inputs an object on a map in handwriting. Note that, Step S31 to Step S33 of FIG. 13 correspond to Step S11 to Step S13 of FIG. 5, and hence description thereof is herein omitted. Step S34 to Step S39 are described below.

In Step S34, the attribute setting unit 7 determines whether or not the user has set a color information attribute indicating whether or not a color being a display form of an object input in handwriting is to be changed in accordance with a display environment of a map. Specifically, the user sets a color information attribute for each object input in handwriting. The color information attribute may be set in such a manner that the user selects “present” or “absent” of a color information attribute in a selection screen displayed in the display 15, for example, but the setting is not limited thereto.

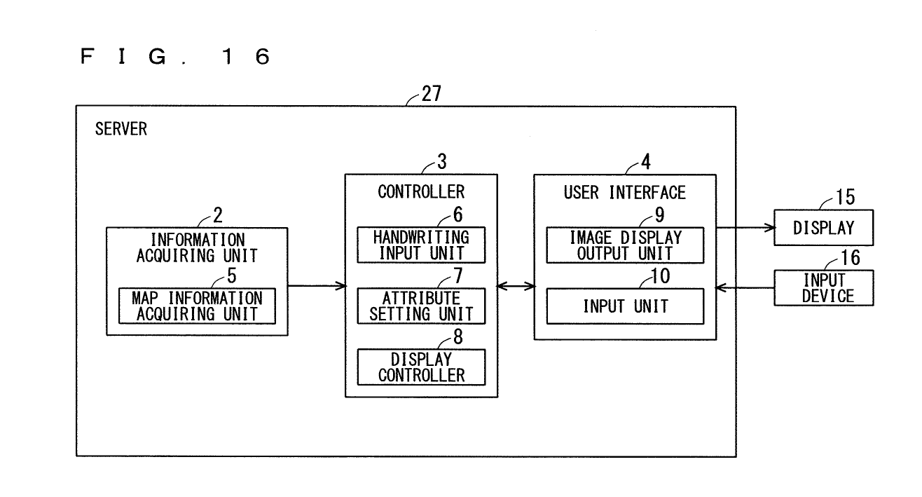

In Step S35, the attribute setting unit 7 stores a color information attribute set by the user in the storage 13 (refer to FIG. 14).

In Step S36, the attribute setting unit 7 determines whether or not the user has set a color for an object set to have a color information attribute being “present.” For example, the setting may be conducted in such a manner that the user selects a color of an object in a selection screen displayed in the display 15, but the setting is not limited thereto.

In Step S37, the attribute setting unit 7 stores a color set by the user in the storage 13 (refer to FIG. 14).

In Step S38, the attribute setting unit 7 determines whether or not the user has set a display mode for an object set to have a color information attribute being “present.” For example, the setting may be conducted in such a manner that the user selects a display mode of an object in a selection screen displayed in the display 15, but the setting is not limited thereto. Here, the display mode means a period of time in which an object is displayed with a color set in Step S36. In this second embodiment, as the display mode, “afternoon” and “night” are given as an example (refer to FIG. 14), but the display mode is not limited thereto. For example, “morning,” “evening,” and the like may be included in the display mode.

In Step S39, the attribute setting unit 7 stores a display mode set by the user in the storage 13 (refer to FIG. 14).

FIG. 15 is a flowchart illustrating an example of operations of the display control apparatus 1 according to this second embodiment, which illustrates an example of operations at the time when the user adds an object input in handwriting to a map to display the object in the display 15. Note that, Step S41 of FIG. 15 corresponds to Step S21 of FIG. 9, and hence description thereof is herein omitted. Step S42 to Step S44 are described below.

In Step S42, the display controller 8 determines whether or not a color information attribute is set for an object to be added to a map. In a case where a color information attribute is set for an object, the process proceeds to Step S43. On the other hand, in a case where a color information attribute is not set for an object, the process proceeds to Step S44.

In Step S43, the display controller 8 controls the image display output unit 9 to make the image display output unit 9 add an object to a map to display the object in the display 15 based on a set color and display mode. That is, the display controller 8 controls the image display output unit 9 to make the image display output unit 9 add an object to a map to display the object in the display 15 while changing a display form of the object in accordance with a display environment of the map. For example, in a case where the object 1 of FIG. 14 is added to a map to be displayed in the display 15, the display controller 8 performs control such that a “red” object 1 is displayed when a display mode is “afternoon,” and performs control such that a “blue” object 1 is displayed when a display mode is “night.”

Note that, as a method of determining a display mode at the time of displaying the object 1, for example, the time when a headlamp of the object vehicle is turned on may be assumed to be “night,” and the time when a headlamp of the object vehicle is turned off may be assumed to be “afternoon.” Further, “afternoon” or “night” may be distinguished in accordance with a predetermined period of time. Further, outside brightness may be detected by an illuminance sensor, and “afternoon” or “night” may be distinguished based on the detection results.

In Step S44, the display controller 8 controls the image display output unit 9 to make the image display output unit 9 add an object obtained at the time of the handwriting input to a map to display the object in the display 15. In this case, even when a display environment of a map is changed, the color of an object to be added to the map is not changed.

Based on the above description, according to this second embodiment, for each object input in handwriting, whether or not the color of the object is to be changed in accordance with a display environment of a map is set. In general, a map in many cases changes its background color depending on a display environment (such as morning, afternoon, evening, and night). Accordingly, visibility of an object can be enhanced by changing the color of the object in accordance with a display environment of a map.

### Modified Example

The first and second embodiments may be combined. That is, the user may set a change attribute and a color information attribute of the object at the time of inputting the object in handwriting. In this case, visibility of an object can be further enhanced.

The display control apparatus described above may be applied not only to a navigation device to be mounted in a vehicle, i.e., a car navigation device, but also to a navigation device constructed as a system that is obtained by combining a portable navigation device (PND) and a mobile communication terminal (such as a mobile phone, a smartphone, and a tablet terminal) that are capable of being mounted in a vehicle, a server, and the like as appropriate. In this case, each function or each component of the display control apparatus is arranged dispersedly in each function constructing the above-mentioned system.

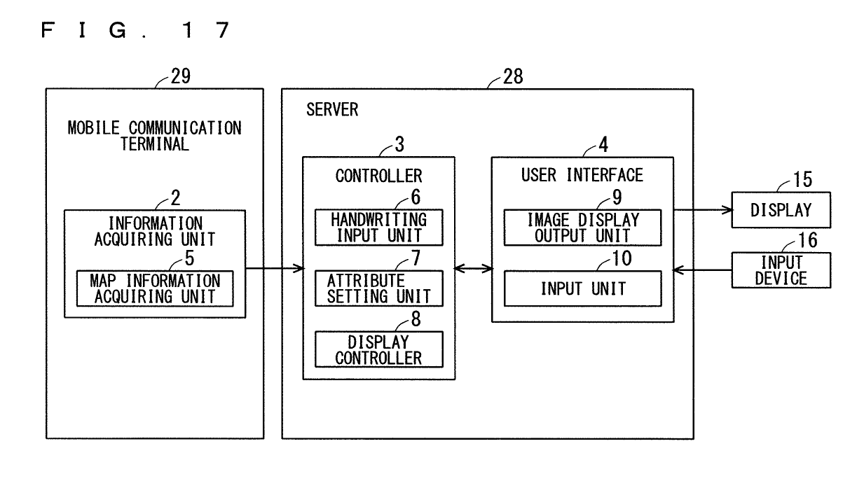

Specifically, as one example, functions of the display control apparatus may be arranged in a server. For example, as illustrated in FIG. 16, a display control system may be constructed by providing the user side with the display 15 and the input device 16, and providing a server 27 with the information acquiring unit 2, the controller 3, the user interface 4, the map information acquiring unit 5, the handwriting input unit 6, the attribute setting unit 7, the display controller 8, the image display output unit 9, and the input unit 10. Note that, the same applies to each component illustrated in FIG. 3 as well.

Further, as another example, functions of the display control apparatus may be arranged in a server and a mobile communication terminal. For example, as illustrated in FIG. 17, a display control system may be constructed by providing the user side with the display 15 and the input device 16, providing a server 28 with the controller 3, the user interface 4, the handwriting input unit 6, the attribute setting unit 7, the display controller 8, the image display output unit 9, and the input unit 10, and providing a mobile communication terminal 29 with the information acquiring unit 2 and the map information acquiring unit 5. Note that, the same applies to each component illustrated in FIG. 3 as well.

Even in a case of employing the configuration described above, the effects similar to those of the embodiments described above can be attained.

Further, software (display control method) for executing the operations in the embodiments described above may be, for example, incorporated in a server or a mobile communication terminal.

Specifically, as one example, in the above-mentioned display control method, a handwriting input of an object on a map displayed in a display is accepted, and presence or absence of an attribute indicating whether or not a display form of the object is to be changed in accordance with a display form or a display environment of the map is set. When an attribute is present, control is performed such that the object is added to the map to be displayed in the display while a display form of the object is changed in accordance with a display form or a display environment of the map based on the set presence or absence of an attribute.

From the above, the effects similar to those of the embodiments described above can be attained by incorporating software for executing the operations in the embodiments described above into a server or a mobile communication terminal and activating the software.

Note that, in the first and second embodiments, at the time of the handwriting input, a line width, a color, and the like of an object may be set as a default. In a case where an attribute is not set for an object input in handwriting (refer to Step S24 of FIG. 9 and Step S44 of FIG. 15), an object set as a default is displayed.

Note that, in the present invention, each of the embodiments may be freely combined, and each of the embodiments may be modified or omitted as appropriate within the scope of the invention.

The present invention has been described in detail, but the above description is in all aspects illustrative, and the present invention is not to be limited thereto. It is understood that numerous unillustrated modified examples are assumable without departing from the scope of the present invention.

### EXPLANATION OF REFERENCE SIGNS

1 display control apparatus, 2 information acquiring unit, 3 controller, 4 user interface, 5 map information acquiring unit, 6 handwriting input unit, 7 attribute setting unit, 8 display controller, 9 image display output unit, 10 input unit, 11 CPU, 12 memory, 13 storage, 14 communication device, 15 display, 16 input device, 17 display control apparatus, 18 vehicle speed information acquiring unit, 19 traffic information acquiring unit, 20 object vehicle location information acquiring unit, 21 object vehicle location determining unit, 22 route calculating unit, 23 voice output unit, 24 voice output device, 25 constructed-structure mark, 26 landmark, 27, 28 server, 29 mobile communication terminal

1. A display control apparatus for controlling display of a map in a display, the display control apparatus comprising:
a processor to execute a program; and
a memory to store the program which, when executed by the processor, performs processes of,
accepting a handwriting input of an object on the map displayed in the display;
setting presence or absence of an attribute indicating whether or not a display form of the object is to be changed in accordance with a display form or a display environment of the map; and
controlling, when the attribute is present, such that the object is added to the map to be displayed in the display while changing the display form of the object in accordance with the display form or the display environment of the map based on the presence or absence of the attribute set by the attribute setting unit.

2. The display control apparatus according to claim 1, wherein
the attribute comprises a change attribute indicating whether or not a size being the display form of the object is to be changed in accordance with a scale being the display form of the map, and
the controlling includes changing, when the change attribute is present, the size of the object in accordance with the scale of the map.

3. The display control apparatus according to claim 2, wherein the controlling includes changing, when the change attribute is present, the size of the object in a range of a predetermined scale of the map, and does not change the size of the object in a range other than the predetermined scale.

4. The display control apparatus according to claim 1, wherein
the attribute comprises a color information attribute indicating whether or not a color being the display form of the object is to be changed in accordance with the display environment of the map, and
the controlling includes changing, when the color information attribute is present, the color of the object in accordance with the display environment of the map.

5. The display control apparatus according to claim 4, wherein the display environment of the map comprises a period of time in which the map is displayed.

6. A display control method of controlling display of a map in a display, the display control method comprising:
accepting a handwriting input of an object on the map displayed in the display;
setting presence or absence of an attribute indicating whether or not a display form of the object is to be changed in accordance with a display form or a display environment of the map; and
controlling, when the attribute is present, such that the object is added to the map to be displayed in the display while changing the display form of the object in accordance with the display form or the display environment of the map based on the set presence or absence of the attribute.
